(19) United States
(12) Patent Application Publication
(10) Pub. No.: US 2010/0061104 A1
(43) Pub. Date: Mar. 11, 2010

(54) Clarifying Filter

(76) Inventor: David Kostuch, Saint Paul, MN (US)

Correspondence Address: DAVID RICHARD KOSTUCH, 1078 REANEY AVE., ST. PAUL, MN, 55106, US

(21) Appl. No.: 12/466,892

(22) Filed: May 15, 2009

Related U.S. Application Data
(63) Continuation of application No. 12/205,904, filed on Sep. 7, 2008.

(51) Int. Cl. F21V 9/00; B32B 3/02

(52) U.S. Cl. 362/311.01; 428/409

(57) ABSTRACT

The clarifying filter is a visual enhancement device in which Liquids, Plasmas, Crystals, or other transparent, translucent, or other non-opaque materials are sandwiched between supporting layers to provide the diffusion provided by such materials to enhance the light provided by a light source.

### CROSS REFERENCE TO RELATED APPLICATIONS

The applications below are the only application related to this application:

This application is a continuation of Continuation-in-Part application Utility patent application Ser. No. 12/205,904 filed on Sep. 7, 2008.

This application claims priority to Continuation-in-Part Utility patent application Ser. No. 12/205,904 filed on Sep. 7, 2008.

This application claims priority to Utility patent application Ser. No. 11/636,892 filed on Dec. 12, 2006.

This application claims priority to PCT Application number US2007/023702 originally filed on Dec. 11, 2007

The clarifying filter is a device for modifying the quality of light passing through it to diffuse the light thereby softening otherwise harsh light sources, or in other cases making light images more intelligible to the eye.

### STATEMENT REGARDING FEDERAL SPONSORSHIP

No invention claimed in this application was made under Federally sponsored research or development.

### BACKGROUND OF INVENTION

Techniques for softening or diffusing the harsh light produced by incandescent, fluorescent, light emitting diode, cathode ray tube, liquid crystal display, electroluminescent, phosphorescent, plasma, and plasma addressed liquid crystal display light sources are available in the art. The present invention provides a novel solution to this problem by utilizing the diffusion of light provided by Liquids, Plasmas, and Crystals.

A number of inventions in the area of electronic signs and digital displays use the concept of materials captured between substrates with least one of which is transparent, however these devices typically are configured to support electronic addressing schemes to produce images which act as light sources by either passing light unobstructed or by causing the materials themselves to glow. U.S. Pat. No. 5,377,029 to Lee et al, and U.S. Pat. No. 4,470,668 to Inoue, et al disclose such electronic display systems.

### BRIEF SUMMARY OF THE INVENTION

The clarifying filter is a visual enhancement device in which Liquids, Plasmas, Crystals, or other transparent, translucent, or other non-opaque materials are sandwiched between supporting layers to provide the diffusion provided by such materials to enhance the light provided by a light source. The materials used in the construction of the clarifying filter may be switchable among Opaque, transparent, translucent states. The clarifying filter may be used with one or more light sources from the group consisting of incandescent, fluorescent, Light emitting diode, cathode ray tube, liquid crystal display, bioluminescent, electroluminescent, phosphorescent, plasma, plasma addressed liquid crystal display. The light source and the clarifying filter may be distinct or integral.

### BRIEF DESCRIPTION OF THE DRAWINGS

FIG. 1 is a side elevation of the visual enhancement device.

FIG. 2 is a sectional view of the invention in the form of a light emitting device.

FIG. 3 is a side elevation of the invention in the form of a lens.

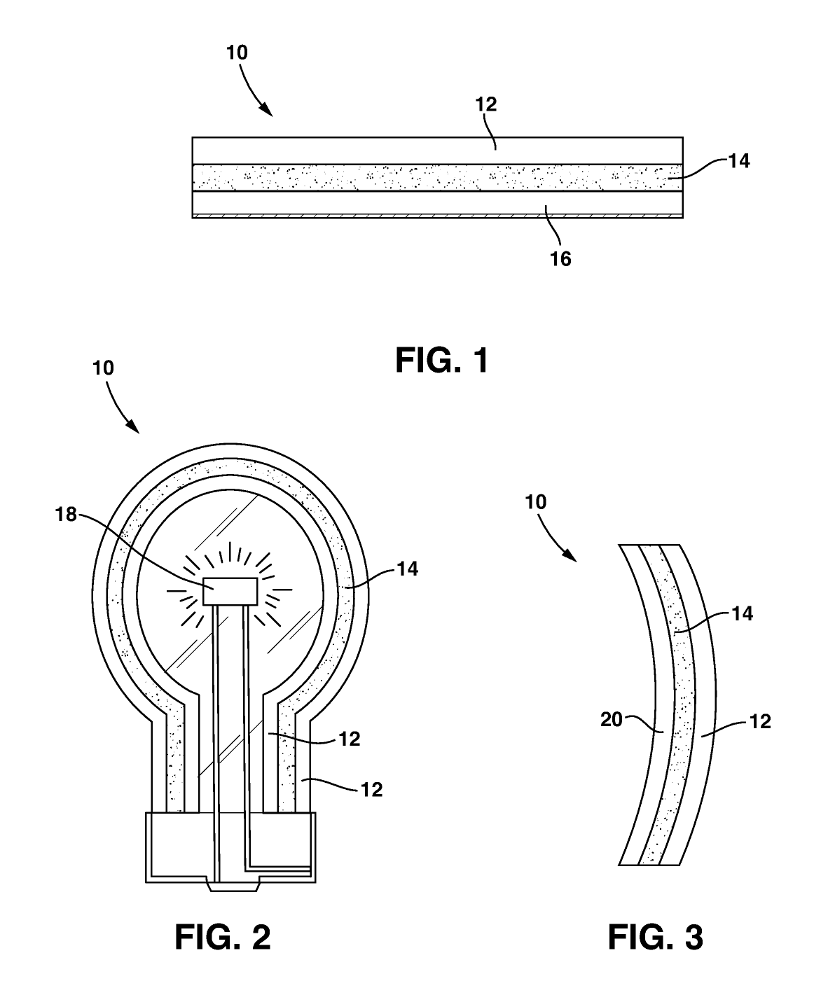

### DETAILED DESCRIPTION

The clarifying filter is a visual enhancement device 10 comprising, two or more support sheets 12, at least one of said support sheets 12 being transparent, said support sheets 12 each having at least one edge and said sheets being fastened at said edges to form one or more cavities and one or more clarifying sheets 14, said clarifying sheets 14 composed of material selected from the group consisting of Liquids, Plasmas, and Crystals, said visual enhancement device 10 constructed from clarifying sheets 14 interleaved between transparent sheets, at least one of said clarifying sheets 14 being disposed within at least one of said cavities.

The clarifying filter may further comprise a light source 18 from the group consisting of incandescent, fluorescent, Light emitting diode, cathode ray tube, liquid crystal display, electroluminescent, phosphorescent, plasma, and plasma addressed liquid crystal display.

One or more of the support sheets 12 may be integral to a light source 18.

One of the support sheets 12 may be a mirror 16.

One of said support sheets 12 is a lens 18.

It will also be appreciated that the clarifying filter's support sheets 12 may consist of a wide variety of materials and devices which serve to support the clarifying filter and contain the clarifying sheets 14. The term clarifying sheet 14 as used herein refers to a sheet of any shape or thickness having one or more edges and constructed of material which is non-opaque at least part of the time.

I claim:

1. A visual enhancement device comprising:
a) two or more support sheets, at least one of said support sheets being transparent, said support sheets each having at least one edge and said sheets being fastened at said edges to form one or more cavities;
b) one or more clarifying sheets, said clarifying sheets composed of material selected from the group consisting of Liquids, Plasmas, and Crystals, said visual enhancement device constructed from clarifying sheets interleaved between transparent sheets, at least one of said clarifying sheets being disposed within at least one of said cavities.

2) The visual enhancement device of claim 1 further comprising a light source from the group consisting of incandescent, fluorescent, Light emitting diode, cathode ray tube, liquid crystal display, electroluminescent, phosphorescent, plasma, and plasma addressed liquid crystal display.

3) The visual enhancement device of claim 1 wherein one or more of the support sheets is integral to a light source.

4) The visual enhancement device of claim 3 further comprising a light source from the group consisting of incandescent, fluorescent, Light emitting diode, cathode ray tube, liquid crystal display, electroluminescent, phosphorescent, plasma, and plasma addressed liquid crystal display.

5) The visual enhancement device of claim 1 wherein one of said support sheets is a mirror.

6) The visual enhancement device of claim 5 further comprising a light source from the group consisting of incandescent, fluorescent, Light emitting diode, cathode ray tube, liquid crystal display, electroluminescent, phosphorescent, plasma, and plasma addressed liquid crystal display.

7) The visual enhancement device of claim 1 wherein one of said support sheets is a lens.

8) The visual enhancement device of claim 7 further comprising a light source from the group consisting of incandescent, fluorescent, Light emitting diode, cathode ray tube, liquid crystal display, electroluminescent, phosphorescent, plasma, and plasma addressed liquid crystal display.
